(19) United States
(12) Patent Application Publication
(10) Pub. No.: US 2010/0167096 A1
(43) Pub. Date: Jul. 1, 2010

(54) System for managing heat transfer in an electronic device to enhance operation of a fuel cell device

(75) Inventor: Michael R. Flannery, Sioux City, IA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 12/317,804

(22) Filed: Dec. 30, 2008

(51) Int. Cl. H01M 8/04

(52) U.S. Cl. 429/24; 429/26

(57) ABSTRACT

A heat management system for a portable electronic device is disclosed. The system comprises a component that generates heat during operation of the component, a fuel cell device configured to provide electrical power to the component to operate the component, and a heat transfer apparatus configured to transfer heat from the component to the fuel cell device when the component operates. In another aspect, a portable information handling device is disclosed that includes a housing defining an interior, a component positioned in the housing that generates heat during operation of the component, a fuel cell device positioned in the housing and configured to provide electrical power to the component to operate the component, and a heat transfer apparatus positioned in or on the housing and configured to transfer heat from the component to the fuel cell device when the component operates.

### BACKGROUND OF THE INVENTION

1. Field of the Invention

The present invention relates to heat management systems for portable electrical devices, and more particularly pertains to a new system for managing heat transfer in an electronic device to enhance operation of a fuel cell device by utilizing waste heat from other components of the device.

2. Description of the Prior Art

Manufacturers of portable electronic devices are continually looking for ways to increase the time that the device will operate in a mode in which the device is not powered by being plugged into a conventional electrical outlet carrying, for example, 120 Volt power. The conventional manner of providing power to the portable device is through the use of an electrical battery, and there has been significant progress in improving the battery technology to increase the charge capacity of the battery and thus extend the time period that the battery is able to provide power to the electrical components of the device.

However, other technologies are being investigated to possibly replace the battery as the primary power source for portable electronic devices, including fuel cell technology. Fuel cell technology has the potential to provide longer operation time periods for portable electronic devices, but technological challenges remain, although these challenges are likely to be overcome as the technology is further researched and developed. Five of the main fuel cell technologies include polymer electrolyte/membrane (commonly referred to as “PEM”), alkaline, phosphoric acid, molten carbonate, and solid oxide. Each of the different fuel cell technologies operates in a different temperature range, and some may use more than one form of “fuel”, including hydrogen, methanol, ethanol, and natural gas. Some of the most promising forms of fuel cell devices operate more effectively and efficiently at relatively higher temperatures, so maintaining the fuel cell device at the higher temperatures is desirable for efficiency purposes.

However, in the design of portable electronic devices, the generation of heat by components of the device, the accumulation of that heat in the interior of the device, and the removal of that heat, poses a challenge to the design of the devices. Thus, generating additional heat to maximize the performance of a fuel cell device can simply exacerbate a problem for engineering the portable electronic device.

It is therefore believed that there is a need for a heat management system for portable electronic devices that employ fuel cell technology for powering the electronic device to control the generation and dissipation of heat in the portable electronic device while at the same time maximizing the operating efficiency of the fuel cell device.

### SUMMARY OF THE INVENTION

The present invention provides a new system for managing heat transfer in an electronic device to enhance operation of a fuel cell device by utilizing heat generated by the operation of one or more components of the electronic device.

In one aspect of the disclosure, a heat management system for a portable electronic device is disclosed. The system comprises a component that generates heat during operation of the component, a fuel cell device configured to provide electrical power to the component to operate the component, and a heat transfer apparatus configured to transfer heat from the component to the fuel cell device when the component operates.

In another aspect of the disclosure, a portable information handling device is disclosed that includes a housing defining an interior, a component positioned in the housing that generates heat during operation of the component, a fuel cell device positioned in the housing and configured to provide electrical power to the component to operate the component, and a heat transfer apparatus positioned in or on the housing and configured to transfer heat from the component to the fuel cell device when the component operates.

The foregoing is a general outline of some of the more significant aspects of the invention, and the detailed description of this application that follows discloses additional features of the invention which form the subject matter of the claims appended hereto.

Advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic diagrammatic depiction of one implementation of the system for managing heat transfer in a portable device of the present invention.

FIG. 2 is a schematic diagrammatic depiction of another implementation of the present invention.

FIG. 3 is a schematic diagrammatic depiction of another implementation of the present invention.

FIG. 4 is a schematic flowchart of an operational aspect of the present invention.

### DESCRIPTION OF PREFERRED EMBODIMENTS

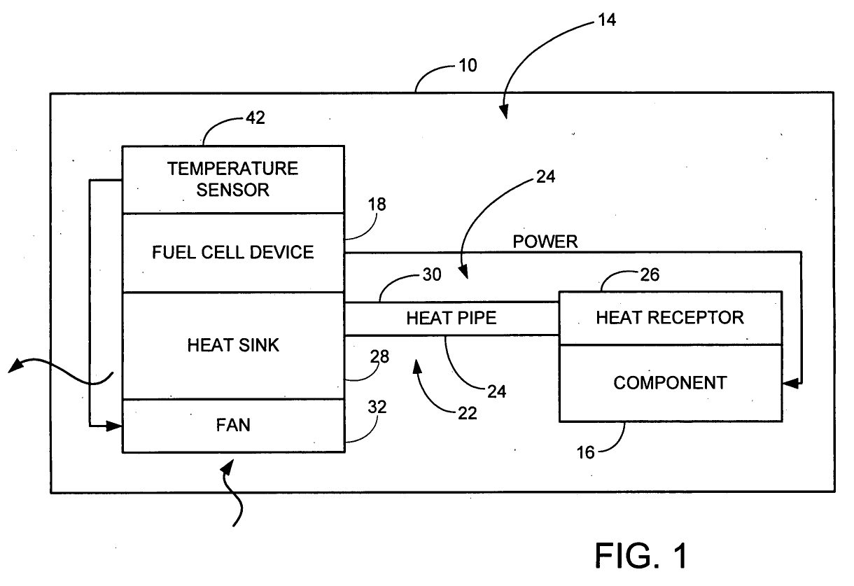

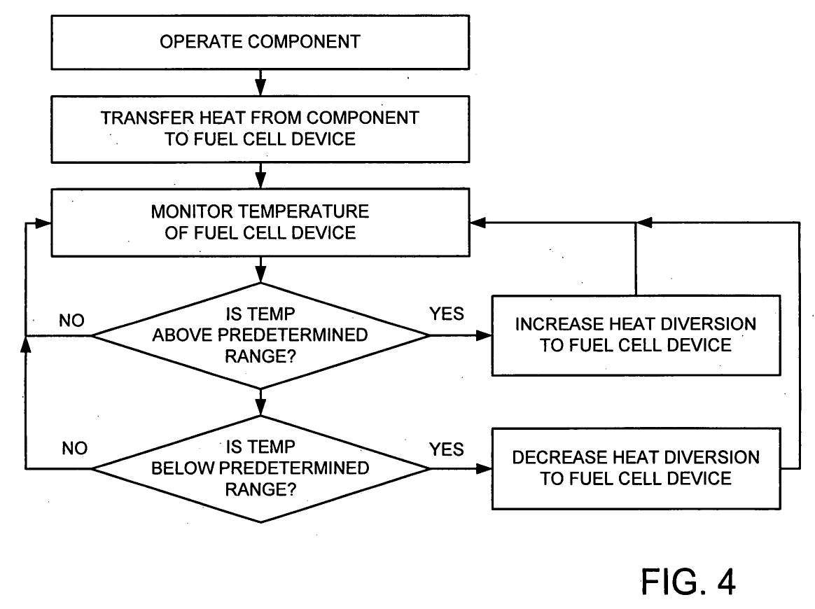

With reference now to the drawings, and in particular to FIGS. 1 through 4 thereof, the system 20 for managing heat transfer in a portable electronic device 10 to enhance operation of a fuel cell device powering the electronic device will be described.

The invention generally comprises a heat management system 20 for a portable electronic device 10. The portable electronic device 10 includes at least one component 16 that generates heat during operation of the device. The device 10 further includes a fuel cell device 18 that generates electrical power to operate aspects of the device 10, typically including the component 16. The fuel cell device 18 suitably requires or at least benefits from the input of heat to achieve optimal or enhanced operating efficiency of the device 18.

The portable electronic device 10 may comprise an information handling system such as a portable or laptop computer, a personal digital assistant (PDA), a communication device such as a cellular phone, or virtually any device that is designed to operate for periods of time without a power cord supplying electrical power to the device during operation. Conventionally, suitable portable electronic devices are operated during these periods of cordless operation by electrical batteries that are charged, depleted of the electrical charge by operation of the device, and then recharged. Fuel cell devices may be employed to replace these electrical batteries and employ a fuel, typically but not necessarily a fluid, to operate the fuel cell device by driving a chemical reaction that results in the generation of electricity. Thus, any electronic device that is suitable for employing a fuel cell device employing current or future technology is suitable for implementation of the present invention.

In this description, the invention will be described in the context of a portable electronic device 10 that is an information handling system such as a portable or laptop computer system, with the understanding that the invention is not limited to portable computers and may be utilized in virtually any devices of the types mentioned above.

In greater detail, as is generally shown in FIGS. 1 through 3, the portable computer electronic device 10 includes a housing 12 that forms the exterior surface of the device, and the housing 12 defines an interior 14 in which all (or at least most) of the components of the portable computer device are positioned.

The component 16 of the portable computer electronic device 10 generates heat during the operation of the component. The component 16 is typically located in the interior 14 of the housing 12, and thus heretofore has required some means for removing the heat from the component 16 so that an excessive amount of heat does not accumulate in the component or in the interior 14 of the housing 12 and possibly affect the operation of or damage the component 16 or other components in the interior of the housing. For example, the component 16 may comprise a computer component, such as an integrated circuit sometimes referred to as a “chip”. Illustratively, the component 16 may comprise a data processing chip, such as the central processing chip of the computer. Processors such as those of the Pentium family available from the Intel Corporation may operate using power in amounts up to 30 Watts or more and at temperatures up to 100 degrees Celsius or more. Although the application of the invention is not limited to processing chips, or processing chips using this range of power or operating at this range of temperature, it is believed that application of the invention to processors provides some of the greatest benefits from the invention. Those skilled in the art will recognize that processors are employed for other purposes in electronic devices, and those processing chips may also benefit from the invention. The invention may also be implemented with memory circuits or chips. Virtually any component of the portable computer system that is powered by electricity is a potential heat source, and thus may be utilized by the invention as a source of heat to be transferred and managed.

As also depicted in FIGS. 1 through 3, the portable computer electronic device 10 includes a fuel cell device 18 that is configured to provide electrical power (either directly or indirectly) to, for example, the component 16 as well other electrical components or elements of the device 10. The fuel cell device 18 may employ virtually any fuel cell technology known or developed in the future. A significant characteristic of the most suitable fuel cell technology employed, and the fuel cell device employed, is that the fuel cell operates most efficiently at a temperature that is greater than the temperature of its environment (e.g., room temperature of approximately 40 degrees Celsius) during operation generating electricity from the fuel. For example, and not by way of limitation, a fuel cell device 18 employing the direct methanol technology requires an operative temperature in the range of approximately 60 degrees Celsius to approximately 100 degrees Celsius to maintain the fuel-to-electricity conversion process in an efficient manner.

The fuel cell device 18 may be positioned in or adjacent to the interior 14 of the housing 12 of the portable computer electronic device 10, and may be located adjacent to the component 16 or may be located relatively remote to the component in the interior. Thus, the proximity of the fuel cell device 18 to the component 12 is not a critical factor to the invention, particularly when a heat transfer apparatus 22 of the heat management system 20 is employed.

The heat transfer apparatus 22 of the system 20 provides means for transferring heat that is generated by operation of the component 16 to the fuel cell device 18 so that the heat may be used to heat the fuel cell device and enhance its operation. The heat transfer apparatus 22 is most suitably located in the interior 14 of the housing 12, although this positioning is not critical to the operation of the invention.

In one highly suitable implementation on the electronic device 10, such as is illustratively shown in FIG. 1, the fuel cell device 18 is positioned in interior 14 of the housing 12 relatively remote to the component 16, and a remote heat exchanger apparatus 24 is employed for transferring heat from component to the remotely positioned fuel cell device 18. In the illustrative embodiment, the remote heat exchanger apparatus 24 includes a heat receptor member 26 that is in thermal communication with the component 16 so that heat may move from the component to the heat receptor member 26. The heat receptor member 26 may be embodied as a thermal transfer plate or a plate-like structure positioned against or in contact with an outer surface of the component. In some embodiments the heat receptor member 26 is mounted on the component 16 with, for example, a thermal interface material positioned therebetween that thermally connects the heat receptor member to the component. This configuration is highly suitable for applications where the component is a processor chip. In other embodiments, the component 16 may be mounted on the heat receptor member 26 in order to create the thermal conduction or connection.

The remote heat exchanger apparatus 24 may also include a heat sink 28 that may be remotely located with respect to the component 16 in the interior 14 of the housing 12. Remote in this sense does not require a large distance of separation, and may include, for example, a relationship in which the heat sink 28 and the component 16 being cooled are quite close to each other but are not in contact with each other, or not sufficiently close to each other so that thermal transfer may occur in an efficient manner sufficient to provide any appreciable cooling through conduction.

The remote heat exchanger apparatus 24 may further include a heat pipe 30 that thermally connects the heat receptor member 26 and the heat sink 28 in a manner that permits heat transferred to the heat receptor member from the component 16 to be transferred from the heat receptor member to the heat sink. Such heat pipes 30 are known to those skilled in the art, and generally employ a highly efficient system of heat transfer that utilizes a sealed and usually elongate container with inner surfaces that have a capillary wicking capability (provided by, for example, fine grooving of the surface or a braid of longitudinally-extending fibers on the surface), a generally open central passage, and a working fluid. Exposure of one end of the heat pipe container to heat causes the liquid working fluid to evaporate to a gaseous state, travel along the passage at the center of the container to the other end of the container, and the fluid condenses back to a liquid at the relatively cooler end of the container. Capillary action causes the liquid working fluid to travel from the relatively cooler end of the container to the relatively hotter end of the container. In this way, heat is transferred from one end of the heat pipe container to the other end of the container. The operation of the heat pipe will not be described in further detail here.

The remote heat exchanger apparatus 24 may also include a heat diverting assembly for removing heat from the heat sink 28, illustratively for the purpose of exhausting heat from the interior 14 of the housing 12. In the illustrative embodiment, a fan 32 is employed to move air over fins of the heat sink 28 so that heat from the heat sink transferred to the air and is taken out of the interior 14 of the housing 12 as the air flows out of the housing. It should be recognized that the air flow induced by the fan 32 may also pass over or across the component 16 and cause heat transfer by convection.

In some embodiments of the invention, the rate at which heat is removed from the heat sink 28 may be adjustable. This adjustability of heat removal may be accomplished by adjusting the amount of air flow moving over the fins of the heat sink, which may be accomplished by adjustment of the speed of rotation of the fan 32, but the adjustment in heat removal could be accomplished in other ways known to those skilled in the art.

Significantly, the heat sink 28 is in thermal communication with the fuel cell device 18 so that the heat in the heat sink may be transferred between the heat sink and the fuel cell device. Heat that is transferred to the heat sink 28 from the component 16 (such as by the heat pipe) may thus in turn be transferred from the heat sink to the fuel cell device 18. Optionally, heat from the fuel cell device 18 may be transferred to the heat sink 28, which in turn could be exhausted to the air flowing over the heat sink to cool the fuel cell device from an excessively hot condition, but the primary focus of the present invention is to provide heat from the component through the heat sink of the remote heat exchanger apparatus as required to make the fuel cell device operation more efficient.

Another significant aspect is a means for controlling heat transfer to the fuel cell device 18 from the component 16, so that the rate at which heat from the component is transferred to the fuel cell device may be controlled by increasing or decreasing the heat transfer rate. The control of heat transfer between the heat sink 28 and the fuel cell device 18 may be accomplished in various ways. In the illustrative embodiment, a heat transfer controlling system 40 includes a temperature sensor 42 that is configured to sense or measure a temperature of the fuel cell device 18 in order to determine if an operative temperature of the fuel cell device is within a desirable range, such as a range in which operation of the fuel cell device is the most efficient. The operative temperature of the fuel cell device 18 may be measured in a number of different ways, including directly measuring the temperature of the various elements of the fuel cell device, such as the anode, cathode, or electrolyte, of the fuel cell device, or fluid being removed from the fuel cell device. The operative temperature of the fuel cell device 18 may also be measured indirectly, such as by detecting the temperature of the exterior of the fuel cell device (such as a surface of a housing of the fuel cell device), and determining the temperature of the fuel cell device as a function of the indirect temperature measurement. Thus, the temperature sensor 42 or the associated circuitry may be calibrated so that the proper or most efficient operating temperature range of the fuel cell device is determinable at the exterior surface of the housing.

In the case where the operative temperature of the fuel cell device 18 is determined to be too low, such as a temperature measurement that is below the range of temperatures where the fuel cell device operates at the most efficient levels, or even in a lower portion of the range of temperatures at which most efficient operation occurs, the heat transfer controlling system 40 may cause relatively more of the heat from the component to be transferred to the fuel cell device 18 rather than, for example, being exhausted to the environment. This transfer of relatively more heat to the fuel cell device 18 may be accomplished by reducing the flow of air over the heat sink 28 so that a relatively lesser quantity of heat is transferred to the air flow and a relatively greater quantity of heat is thus available to be transferred to the fuel cell device. In the illustrative embodiment, the rotational speed of the fan 32 may be decreased (or optionally the rotation of the fan may be stopped) to reduce the transfer of heat to the air flow over the heat sink.

In contrast, in the case where the operative temperature of the fuel cell device 18 is determined to be too high, such as a temperature measurement that is above the range of temperatures where the fuel cell device operates at the most efficient levels, or even in an upper portion of the range of temperatures at which most efficient operation occurs, the heat transfer controlling system 40 may cause relatively less of the heat from the component 16 to be transferred to the fuel cell device 18 and instead be, for example, transferred to air flowing over the heat sink 28 and being exhausted to the environment outside of the housing of the portable electronic device 10. This transfer of relatively less heat to the fuel cell device 18 may be accomplished by increasing the flow of air over the heat sink 28 so that a relatively greater quantity of heat is transferred to the air flow and a relatively lesser quantity of heat is thus available to be transferred to the fuel cell device. In the illustrative embodiment, the rotational speed of the fan 32 may be increased (or optionally rotation may be started if the fan is stopped) to increase the transfer of heat to the air flow over the heat sink 28. Optionally, the transfer of heat to the fuel cell device 10 from the heat sink 28 may be controlled in other ways.

Other manners of heat transfer between the component and the fuel cell device may be utilized.

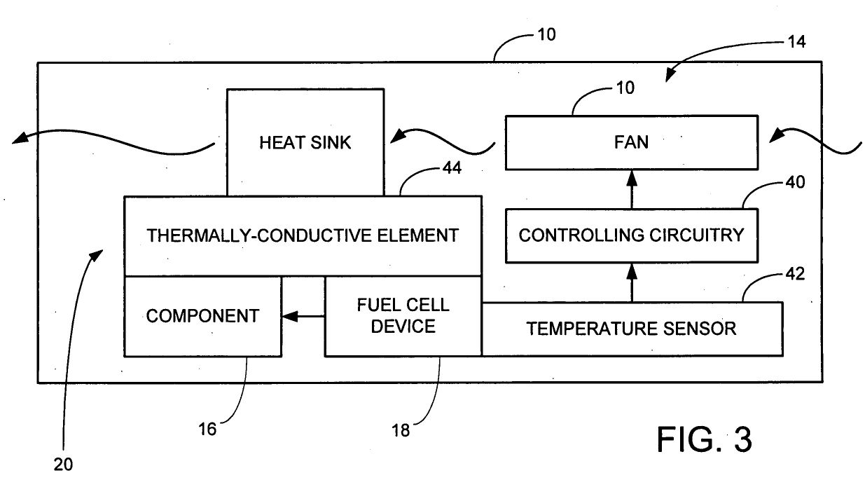

For example, in one variation of the invention, such as is schematically depicted in FIG. 3 of the drawings, the component 16 and the fuel cell device 18 may be positioned relatively closer together than in the previously described implementation, but the component and the fuel cell device are not necessarily positioned directly adjacent to each other. In this variation, the heat transfer apparatus 22 comprises a thermally-conductive element 46 positioned adjacent to and in thermal communication with the component 16 and is positioned adjacent to and in thermal communication with the fuel cell device 18. The thermally-conductive element 22 may be in contact with the component 16 and in contact with the fuel cell device 18, and may comprise a heat spreader plate that thermally communicates with both the component and the fuel cell device. Illustratively, the heat spreader plate 44 may be formed of a heat conductive material, for example a metal such as copper or aluminum. In this embodiment, the conduction of heat from the component 16 to the heat spreader plate 44 and from the heat spreader plate 44 to the fuel cell device 18 accomplishes the relative cooling of the component and the relative heating of the fuel cell device. In this embodiment, controlling the heat transfer to the fuel cell may be accomplished, for example, by placing a heat sink 28 in thermal communication with the heat spreader plate 44, and varying the flow of air over the heat sink (or the spreader plate itself) according to the heating requirements of the fuel cell device. As noted previously, passing more air over the heat sink 28 or spreader plate 44 will cause a greater quantity of heat to be dissipated to the air than is transferred to the fuel cell device 18, so that the fuel cell device will not be provided with as much heat. The waste heat of the component is thus diverted (to a varying degree) from moving to the fuel cell device and moves instead to the air flow.

A contemplated variation of the latter embodiment would place the fuel cell device in direct contact with the component for effecting the heat transfer.

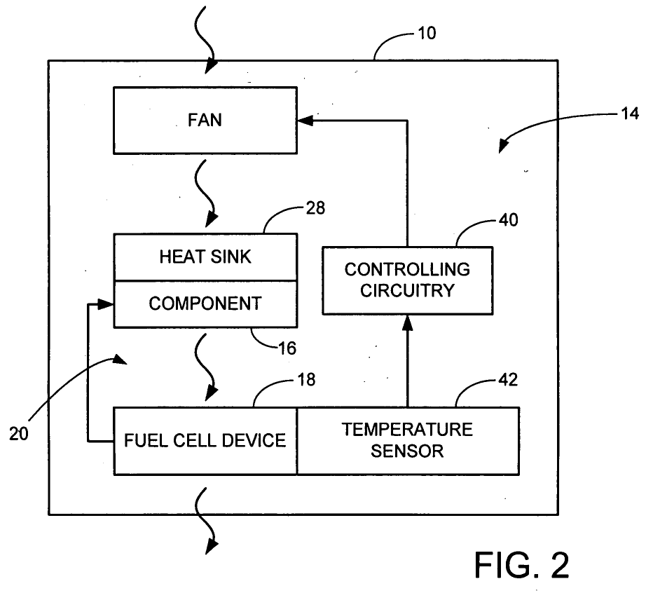

In another variation of the invention, such as is schematically depicted in FIG. 2, the component 16 and the fuel cell device 18 may be positioned relatively adjacent to each other in the interior 14 of the housing 12, and the movement of air induced in the interior of the housing transfers or moves the heat generated by the component to the fuel cell device 18 through the air flow. For example, a fan 32 may be employed to cause a flow of air over a heat sink 28 that is mounted on and in thermal communication with the component 16, and the fuel cell device may be positioned such that the air flow passes by or over the fuel cell device after the air has flowed over the heat sink. This implementation may be relatively less effective than the more preferred implementations, as the air flow may not be the most effective and efficient means for transferring heat between the component and the fuel cell device, and the air flow may draw heat from the fuel cell device.

The foregoing is considered as illustrative only of the principles of the invention. Further, since numerous modifications and changes will readily occur to those skilled in the art in view of the disclosure of this application, it is not desired to limit the invention to the exact embodiments, implementations, and operations shown and described. Accordingly, all equivalent relationships to those illustrated in the drawings and described in the specification, including all suitable modifications, are intended to be encompassed by the present invention that fall within the scope of the invention.

I claim:

1. A heat management system for a portable electronic device, the system comprising:
a component that generates heat during operation of the component;
a fuel cell device configured to provide electrical power to the component to operate the component; and
a heat transfer apparatus configured to transfer heat from the component to the fuel cell device when the component operates.

2. The system of claim 1 wherein the component is configured to operate on electricity generated by the fuel cell device and directly supplied to the component from the fuel cell.

3. The system of claim 1 further comprising a heat transfer controlling apparatus configured to control transfer of heat by the heat transfer apparatus.

4. The system of claim 3 wherein the heat transfer controlling apparatus comprises:
a temperature sensor configured to sense a temperature of the fuel cell device; and
a heat diverting assembly configured to transfer heat away from the fuel cell device, the heat diverting assembly being in communication with and being responsive to the temperature sensor.

5. The system of claim 4 wherein the heat diverting assembly comprises a fan for moving a flow of air over a portion of the heat transfer apparatus.

6. The system of claim 1 wherein the component and the fuel cell device are positioned in a housing of the portable electronic device, and wherein the component and the fuel cell device are adjacent to each other in the interior of the housing such that air movement in the interior moves heat generated by the component to the fuel cell device.

7. The system of claim 1 wherein the heat transfer apparatus comprises a thermally-conductive element in thermal communication with the component and in thermal communication with the fuel cell device.

8. The system of claim 7 wherein the thermally-conductive element comprises a heat spreader plate in contact with the component and in contact with the fuel cell device.

9. The system of claim 7 wherein the fuel cell device is positioned relatively remote to the component in the housing, and wherein the thermally-conductive element comprises a remote heat exchanger apparatus configured to transfer heat between the component and the remotely positioned fuel cell device.

10. The system of claim 9 wherein the remote heat exchanger apparatus comprises:
a heat receptor member in thermal communication with the component such that heat of the component is conducted to the heat receptor member;
a heat sink in thermal communication with the fuel cell device; and
a heat pipe thermally connecting the heat receptor member and the heat sink in a manner permitting heat transferred to the heat receptor member from the component to be transferred from the heat receptor member to the heat sink.

11. The system of claim 10 additionally comprising a heat diverting assembly configured to remove heat from the heat sink.

12. The system of claim 11 wherein the heat diverting assembly comprises a fan configured to move air over the heat sink so that a portion of the heat from the heat sink is transferred to the air and is the portion of the heat is not transferred to the fuel cell device.

13. The system of claim 11 wherein operation of the heat diverting assembly is adjustable such that a rate at which heat is removed from the heat sink is adjustable.

14. The system of claim 13 wherein the heat diverting assembly comprises a fan configured to move air over the heat sink so that a portion of the heat from the heat sink is transferred to the air, and wherein a speed of rotation of the fan is adjustable.

15. The system of claim 13 additionally comprising a temperature sensor configured to sense a temperature of the fuel cell device, and the heat diverting assembly is responsive to a temperature of the fuel cell apparatus sensed by the temperature sensor.

16. A portable information handling device comprising:
a housing defining an interior;
a component positioned in the housing that generates heat during operation of the component;
a fuel cell device positioned in the housing and configured to provide electrical power to the component to operate the component; and
a heat transfer apparatus positioned in the housing and configured to transfer heat from the component to the fuel cell device when the component operates.

17. The device of claim 16 further comprising a heat transfer controlling apparatus configured to control transfer of heat by the heat transfer apparatus between the component and the fuel cell device.

18. The device of claim 17 wherein the heat transfer controlling apparatus comprises:
a temperature sensor configured to sense a temperature of the fuel cell device; and
a heat diverting assembly configured to transfer heat away from the fuel cell device, the heat diverting assembly being in communication with and being responsive to the temperature sensor.

19. The device of claim 17 wherein the heat transfer controlling apparatus comprises:
a temperature sensor configured to sense a temperature of the fuel cell device; and
a heat diverting assembly configured to transfer heat away from the component, the heat diverting assembly being in communication with and being responsive to the temperature sensor.
